(19) United States
(12) Patent Application Publication
(10) Pub. No.: US 2007/0229669 A1
(43) Pub. Date: Oct. 4, 2007

(54) Portable Terminal

(75) Inventor: Kazuhiro Yamamoto, Yokohama-shi (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi (JP)

(21) Appl. No.: 10/599,450

(22) PCT Filed: Mar. 30, 2005
(86) PCT No.: PCT/JP05/06136

§ 371 Date: May 23, 2007

(30) Foreign Application Priority Data
Mar. 31, 2004 (JP) 2004-101679

(51) Int. Cl. H04N 5/225

(52) U.S. Cl. 348/207.99; 348/E05.025

(57) ABSTRACT

A portable terminal includes: a photographic unit for photographing an object; an acceleration sensor for measuring acceleration: and a control unit for disenabling photographing by the photographic unit when the acceleration sensor produces a predetermined output after the photographic unit is set to a photographic mode.

### TECHNICAL FIELD

The present invention relates to a portable terminal such as a portable telephone with a camera attached thereto having a piracy prevention function.

Priority is claimed on Japanese Patent Application No. 2004-101679, filed Mar. 31, 2004, the content of which is incorporated herein by reference.

### BACKGROUND ART

In recent years, portable telephones with a camera have been in wide use. However, malicious pirating acts without authorization using this terminal have been repeatedly performed. For this reason, many kinds of portable terminals having the following piracy prevention functions have been proposed.

(1) With regard to a foldable type of portable terminal, the photographing of the portable terminal can be allowed only when a folding mechanism is completely open, and is prohibited when the mechanism is incompletely open.

(2) When an inclination sensor detects that the terminal is inclined at an unnatural angle, the photographing by the portable terminal is prohibited

(3) By emitting a sub-display that can work together with a function of the photographing, it is notified to the surroundings that the photographing is being conducted.

(4) By sending shutter sounds during the photographing, it is notified to the surroundings that the photographing is being conducted.

In addition, portable terminals having a camera are disclosed in Unexamined Japanese Patent Application, First Publication 2004-64138.

However, with regard to item (1), since the terminal having a completely open state can take pictures, item (1) provides insufficient piracy deterrence effects.

As for item (2), it is inconvenient that there is an angle which does not allow taking pictures.

Regarding item (3), covering the light emitting element by an object greatly decreases piracy deterrence effects.

As to item (4). employing the shutter sound in a noisy environment does not yield piracy deterrence effects.

There are the problems as described above.

### DISCLOSURE OF INVENTION

Problems to be Solved by the Invention

The invention is designed to enhance the piracy deterrence effects of a camera equipped portable terminal.

Means for Solving the Problem

The portable terminal according to the invention includes a photographic unit for photographing an object; an acceleration sensor for measuring acceleration; and a control unit for disenabling photographing by the photographic unit when the acceleration sensor produces a predetermined output after the photographic unit is set to a photographic mode.

The portable terminal according to the invention includes a photographic unit for photographing an object; an acceleration sensor for measuring acceleration; and a control unit for prohibiting preservation of the data photographed by the photographic unit when the acceleration sensor produces a predetermined output after the photographic unit is set to a photographic mode.

The portable terminal according to the invention includes a photographic unit for photographing an object; an acceleration sensor for measuring acceleration; and a control unit for erasing the temporarily stored data photographed by the photographic unit and canceling a photographic mode when the acceleration sensor produces a predetermined output after the photographic unit is set to the photographic mode.

The portable terminal according to the invention includes a photographic unit for photographing an object; an acceleration sensor for measuring acceleration; and a control unit for prohibiting display of the data photographed by the photographic unit when the acceleration sensor produces a predetermined output after the photographic unit is set to the photographic mode.

The portable terminal according to the invention includes a photographic unit for photographing an object; an acceleration sensor for measuring acceleration; and a control unit for prohibiting preservation of the data photographed by the photographic unit and ending a photographic operation when the acceleration sensor produces a predetermined output during the time the photographic unit is photographing.

The portable terminal according to the invention includes a photographic unit for photographing an object; a detector unit for detecting a number of times for handoff for a predetermined period of time; a control unit for disenabling photographing by the photographic unit when the detector unit detects more than a predetermined number of times for handoff after the photographic unit is set to a photographic mode.

The portable terminal according to the invention includes a photographic unit for photographing an object; a detector unit for detecting a number of times for position record for a predetermined period of time; and a control unit for disenabling photographing by the photographic unit when the detector unit detects more position records than a predetermined number of times after the photographic unit is set to a photographic mode.

### EFFECTS OF THE INVENTION

The invention deters or prohibits pirating acts more effectively by a portable terminal such as a camera equipped portable terminal than in the prior art.

### BRIEF DESCRIPTION OF THE DRAWINGS

FIG. 1 is a block diagram for showing a structure of a camera equipped portable terminal according to a first embodiment of the invention.

FIG. 2 is a flowchart showing a function of the camera equipped portable terminal according to the first embodiment of the invention.

FIG. 3 is a flowchart showing a function of the camera equipped portable terminal according to the first embodiment of the invention.

FIG. 4 is a structural view of illustrating a magnitude of each of the acceleration.

FIG. 5 is a flowchart showing a function of a camera equipped portable terminal according to a second embodiment of the invention.

FIG. 6 is a flowchart showing a function of a camera equipped portable terminal according to a third embodiment of the invention.

FIG. 7 is a flowchart showing a function of a camera equipped portable terminal according to a fourth embodiment of the invention.

FIG. 8 is a flowchart showing a function of a camera equipped portable terminal according to a fifth embodiment of the invention.

FIG. 9 is a flowchart showing a function of a camera equipped portable terminal according to a sixth embodiment of the invention.

### DESCRIPTION OF THE REFERENCE SYMBOLS

1: control unit, 2: screen display unit, 3: voice output unit, 4: voice input unit, 5: key operation unit, 6: acceleration sensor, 7: acceleration detector, 8: radio communication unit, 9: annunciator unit, 10: timer unit, 11: memory unit, 12: camera unit, 13: radio base station, 14: communication network, 100: camera equipped portable terminal

### BEST MODE FOR CARRYING OUT THE INVENTION

The embodiments of the invention will be discussed below referring to the figures.

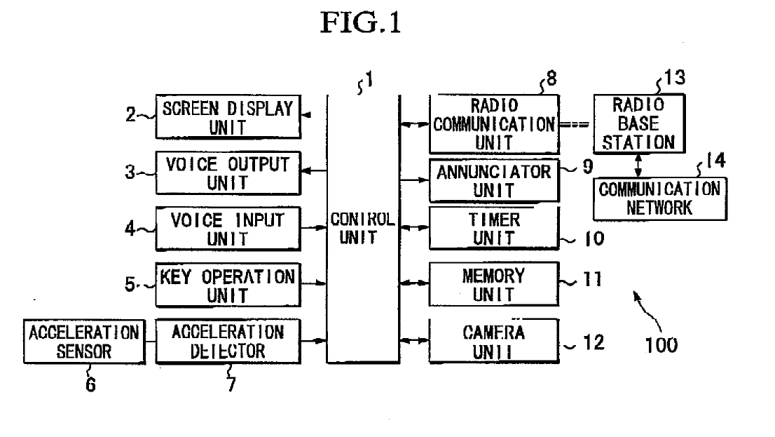

FIG. 1 is a block diagram for showing a structure of a camera equipped portable terminal 100 according to a first embodiment of the invention.

The camera equipped portable terminal 100 according to the invention includes a portable telephone having a camera, and a portable information terminal having a camera (PDA).

In FIG. 1, the camera equipped portable terminal 100 includes a control unit 1, a screen display unit 2, a voice output unit 3, a voice input unit 4, a key operation unit 5, an acceleration sensor 6, an acceleration detector 7, a radio communication unit 8, an annunciator unit 9, a timer unit 10, a memory unit 11, a camera unit 12, and the like The radio communication unit 8 communicates with a communication network 14 via a radio base station 13.

Next, an example of function will be described.

(1) When the camera equipped portable terminal 100 is set at a state in which a camera can be used for photograph (a camera mode), acceleration applied to the camera equipped portable terminal 100 is monitored by the acceleration sensor 6. When the acceleration detector 7 has detected an acceleration greater than a predetermined value, photographing is disabled for a period of time from the time detected.

(2) Moreover, in a case where an acceleration greater than a predetermined value has been detected while a period of constant time has elapsed from right after executing photographing, preservation of the image data derived from the photographing is disabled.

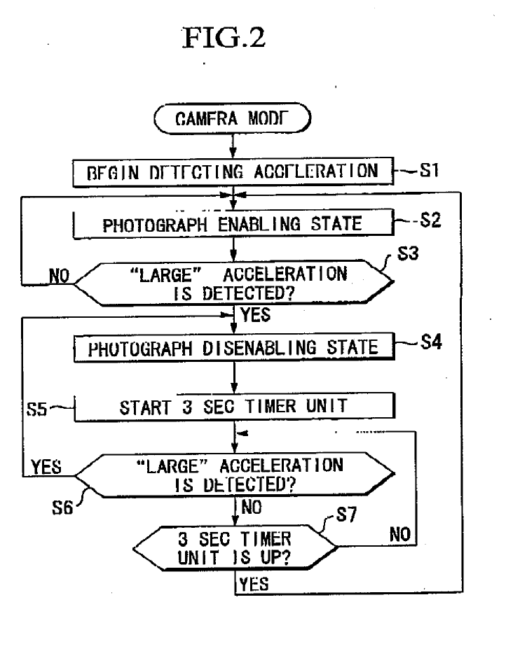

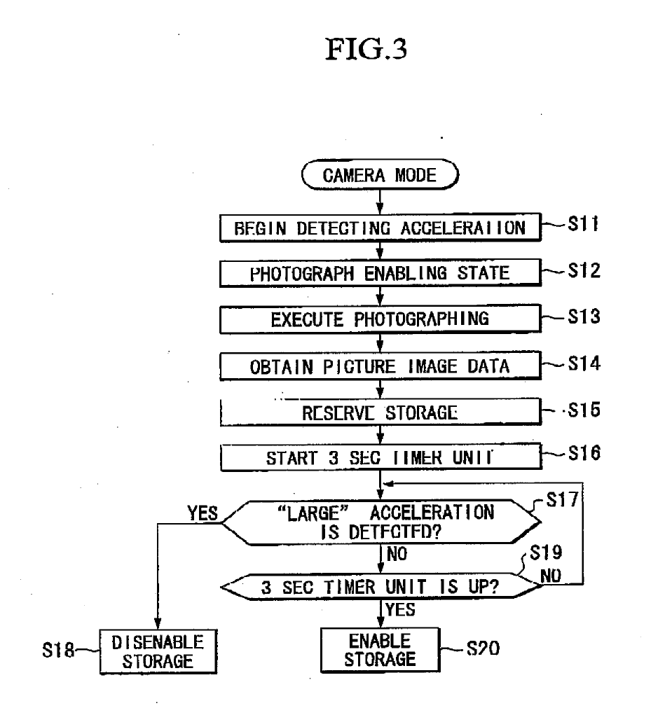

FIG. 2 is a flowchart for (1) above, while FIG. 3 is a flowchart for (2) above.

In FIG. 2, the state of the camera equipped portable terminal 100 is changed in a camera mode, an acceleration applied to the camera equipped portable terminal 100 begins to be measured by the acceleration sensor 6 and the acceleration detector 7 (S1), and at the same time, the camera unit 12 is put into a state that enables photographing (referred to as a “photograph enabling state” hereinbelow) (S2). Unless the acceleration measured exceeds a predetermined value (S3, NO), the photograph enabling state continues. When an acceleration greater than a predetermined value is detected (S3, YES), the camera is forced to a mode by which the photograph is disabled from the time detected (a state in which operation of photographing cannot be not accepted, or pressing shutter becomes invalid) (referred to as “photograph disabling mode” hereinbelow), and simultaneously the timer 10 begins to measure a period of three seconds (S5). If an acceleration greater than a predetermined value is detected while the three seconds pass (S6, YES), the photograph disabling mode continues. If acceleration becomes lower than a predetermined value for a period of three seconds, after a period of three seconds (S7, YES), the photograph disabling mode is cancelled, which leads to the photograph enabling state (S2).

When the camera is in the photograph enabling state, if the shutter is pressed, the sequence in accordance with the flowchart of FIG. 3 is executed.

In FIG. 3, the sequence is switched into the camera mode to begin to detect acceleration (S11), and concurrently the camera 12 unit is put into the photograph enabling state (S12). Then the shutter is pressed to execute photographing (S13), the image data obtained by photographing is incorporated (S14). The image data is, for example, temporally incorporated into a RAM in the control unit 1 to reserve storage (S15). Together with this, the timer unit 10 begins to measure a period of three seconds (S16). When an acceleration greater than a predetermined value is detected (S17, YES) for this period of three seconds, the image data stored temporally above can no longer be stored to cancel the image data in the RAM (S18). In contrast, when acceleration is lower than a predetermined value for a period of three seconds, after three seconds (S19, YES), the image data can be stored, which allows the image data in the RAM to be transferred to the memory 11 and stored therein, or to be stored in the memory unit 11 by the operation of a user (S20).

When the shutter is pressed during the photograph enabling state, the images taken are generally displayed on the screen display 2; however, it is possible that the images taken are not supposed to be displayed. That is, in a case where acceleration greater than a predetermined value is detected for a period of three seconds after execution of the photographing, the images taken are prohibited from being displayed. In this case, too, if an acceleration lower than a predetermined value is detected for a period of three seconds, after three seconds, the image data can be displayed.

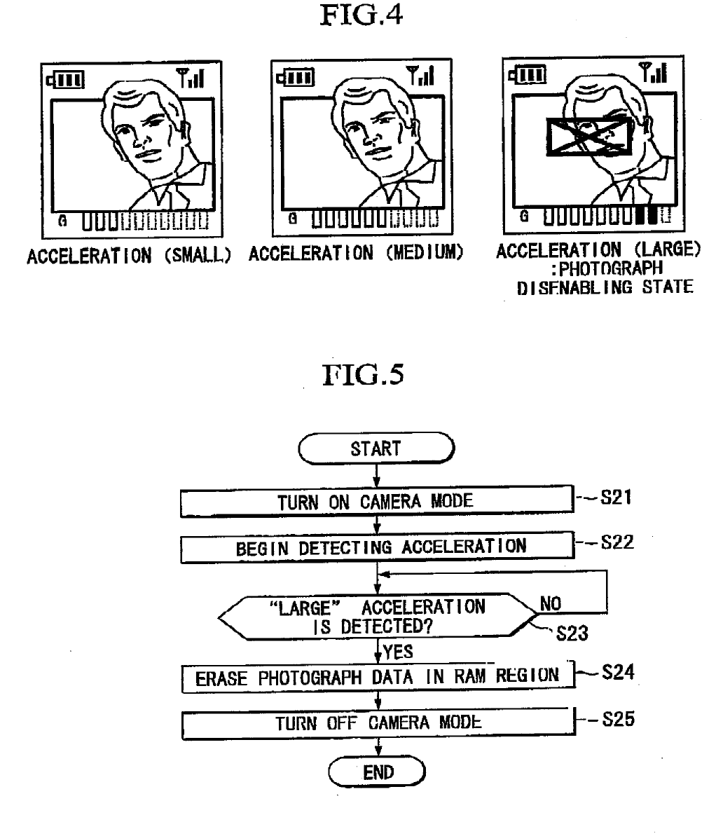

Furthermore, as shown in FIG. 4, while the camera equipped portable terminal 100 is in the camera mode (which includes a photograph disenabling state and an image data storage reserving state), the magnitude of the acceleration being measured may be shown in real time to allow a user to judge quantitatively.

The embodiment according to the invention provides the following advantages.

(a) When acceleration applied to the camera equipped portable terminal 100 is greater than a predetermined value, execution of photographing and storage of the image data after photographing are limited. Accordingly, for example, in a state having a speedy movement in which a user quickly takes the camera equipped portable terminal 100 out of his pocket for photographing, or after photographing quickly puts the terminal back into the pocket, executing photograph or storing the image data is disabled. The camera equipped portable terminal 100 can allow photographing only in a steady state having a slow movement, which as a result prevents or deters pirating acts.

(b) When an acceleration greater than a predetermined value is detected while the camera equipped portable terminal 100 is in the camera mode, that makes photography disenabled (the state which does not accept photograph operation). Accordingly, pirating acts are effectively deterred or prohibited.

(c) Even if the photographing is disabled, when a predetermined period of time has clasped without detecting an acceleration greater than a predetermined value, the photograph disenabling state is cancelled to resume a photograph enabling state. Hence, time to start up a camera application once again is saved.

(d) When an acceleration greater than a predetermined value is detected during the time a predetermine period of time has passed after photographing, the image data photographed cannot be stored or prohibited from displaying. Consequently, as a result, pirating acts can be prevented.

(e) After executing photographing, the data obtained by the photographing is in a storage reserving state. When, in this state, an acceleration greater than a predetermined value is detected, storage is disenabled or display or prohibited to cancel the image data. Therefore, as a result, pirating acts can be prevented.

(f) When a predetermined period of time has passed without detecting an acceleration greater than a predetermined value, a preservation reserving state is cancelled, which allows the image data to be stored. Accordingly, only the images correctly photographed can be stored.

The second embodiment according to the invention will be described, referring to the flowcharts of FIG. 5.

In FIG. 5, when the state of the camera equipped portable terminal 100 is changed to a camera mode, the camera unit 12 is turned into a photograph enabling state (S21). Concurrently, acceleration applied to the camera equipped portable terminal 100 begins to be detected by the acceleration sensor 6 and the acceleration detector 7 (S22). When the measured acceleration is not greater than a predetermined value (S23, NO), the photograph enabling state continues. On the other hand, when the acceleration greater than a predetermined value is detected (S23, YES), the image data stored photographed during that time and stored temporarily are all erased (S24), and at the same time the camera mode is cancelled (S24).

According to the embodiment, acceleration greater than a predetermined value is detected after the camera equipped portable terminal 100 is set in the camera mode, the image data in the RAM region is erased, and at the same time the camera mode can be forced to be cancelled. Hence, photographing is allowed only in a stable state having little movement at the camera equipped portable terminal 100, which can prevent or deter pirating acts. Moreover, canceling a camera mode can prevent continuous photographing.

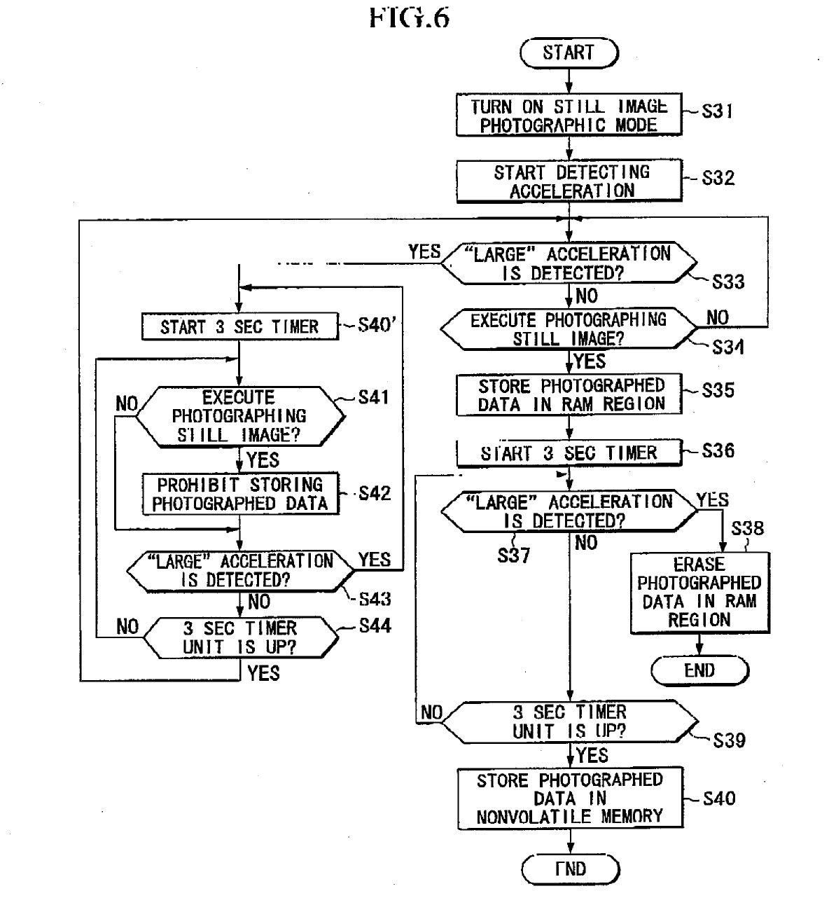

The third embodiment according to the invention will be described referring to the flowchart shown in FIG. 6.

In FIG. 6, a static or still image photographic mode is set (S31), the detection of acceleration is begun (S32). When, with the acceleration being lower than a predetermined value (S33, NO), a shutter is pressed to execute still image photography (S34, YES), still image data photographed is temporarily stored in the RAM (S35). Concurrently, the timer unit 10 begins to measure three seconds (S36). When an acceleration greater than a predetermined value is detected during this period of three seconds (S37, YES), the still image data stored temporarily is cancelled, and the photographic operation is ended (S38). In contrast, when acceleration is lower than a predetermined value for three seconds (S37, NO), the still image data can be stored after the three seconds (S39, YES), and the still image data in the RAM can be transferred to the memory unit 11 such as a nonvolatile memory to be stored therein, or stored in the memory unit 11 by a user operation (S40).

In a case where an acceleration greater than a predetermined value is detected at step S33 (S33, YES), the measurement of the period of the three seconds is begun (S40). If still image photographing is carried out for three seconds (S41, YES), the preservation of the still image data photographed is prohibited (S42). In the meantime, if acceleration is lower than a predetermined value for three seconds (S43, NO), after a period of three seconds (S44, YES) the sequence of the flowchart of FIG. 6 proceeds to step S33. Even in a case where still image photographing is not performed for a period of three seconds (S41, NO), if acceleration is lower than a predetermined value, the sequence proceeds to step S33 after a period of three seconds.

According to the embodiment, when a quick movement has happened after photographing a still image or the photographing is carried out during the time a quick movement is happening, photographed still image data is destroyed and photographic operations end simultaneously.

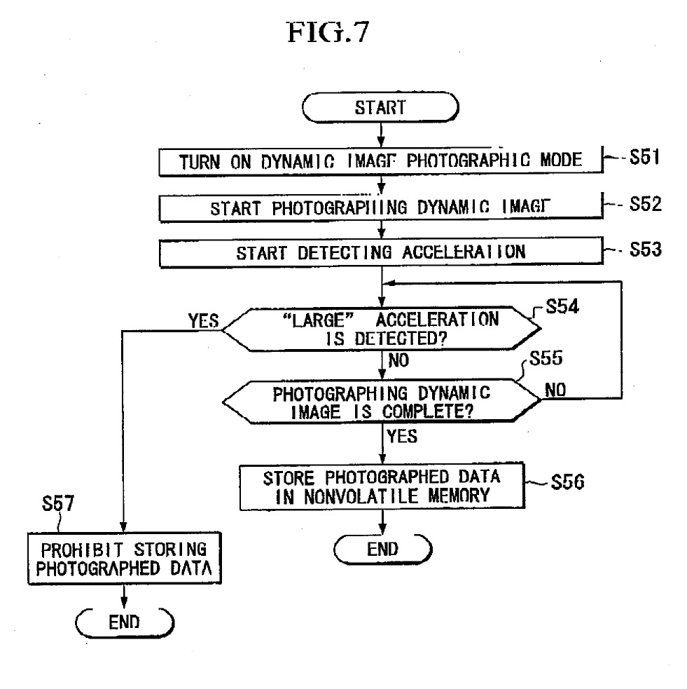

The fourth embodiment according to the invention will be described referring to the flowchart shown in FIG. 7.

InFIG. 7, a dynamic image photographic mode is set (S51). When a shutter is pressed to begin dynamic image photographing (S52), the detection of acceleration begins (S53). Where the acceleration is lower than a predetermined value (S54, NO), when dynamic image photographing is complete (S55, YES), the dynamic image data photographed can be stored in the nonvolatile memory or stored in the nonvolatile memory by a user operation (S56). Meanwhile, when an acceleration greater than a predetermined value is detected (S54, YES), the photographed dynamic image data is prohibited from being stored, and the photographic operations end (S57).

According to the embodiment, when a quick movement has happened while photographing a dynamic image, the photographed dynamic image data is immediately prohibited from being stored and photographic operations end.

With regard to the third and fourth embodiments, the display of the photographic images when the acceleration is large may be prohibited or may be like the display of acceleration shown in FIG. 4.

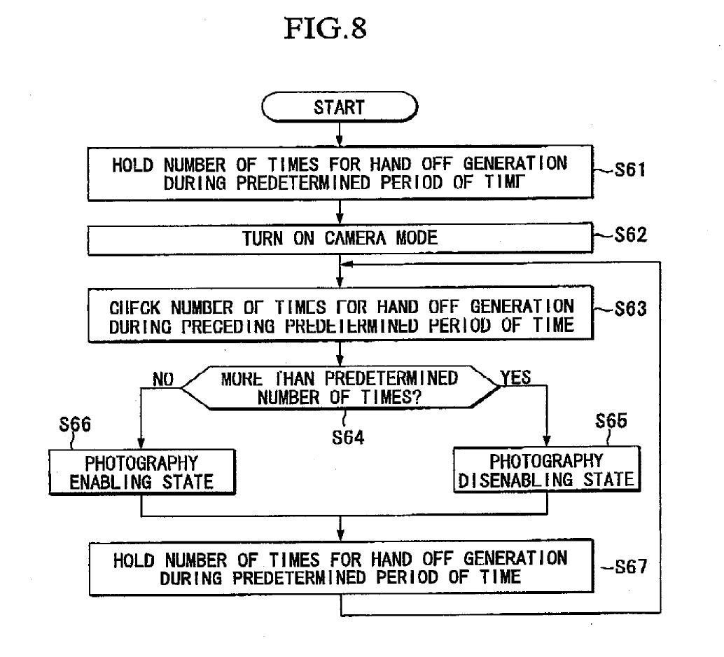

The fifth embodiment according to the invention will be discussed referring to the flowchart shown in FIG. 8.

The camera equipped portable terminal 100 always holds the number of times for handoff generation for a predetermined period of time (S61). When the camera equipped portable terminal 100 is set in a camera mode at this state (S62), the number of times for handoff generation for the previous predetermined period of time is checked (S63). If the checked number of times is greater than a predetermined number of times (S64, YES), the photographing is disabled. i.e., the photograph disabling mode is produced (S65). In the mean time, if the checked number of times is less than a predetermined number of times (S64, NO), the photographing is enabled, namely, the photograph enabling mode is produced (S66). After holding the number of times for handoff generation for a subsequent predetermined period of time (S67), the sequence of the flowchart of FIG. 8 proceeds to step S63.

A detection unit for detecting the number of times for handoff generation is provided instead of the acceleration sensor 6 and the acceleration detector 7 in FIG. 1.

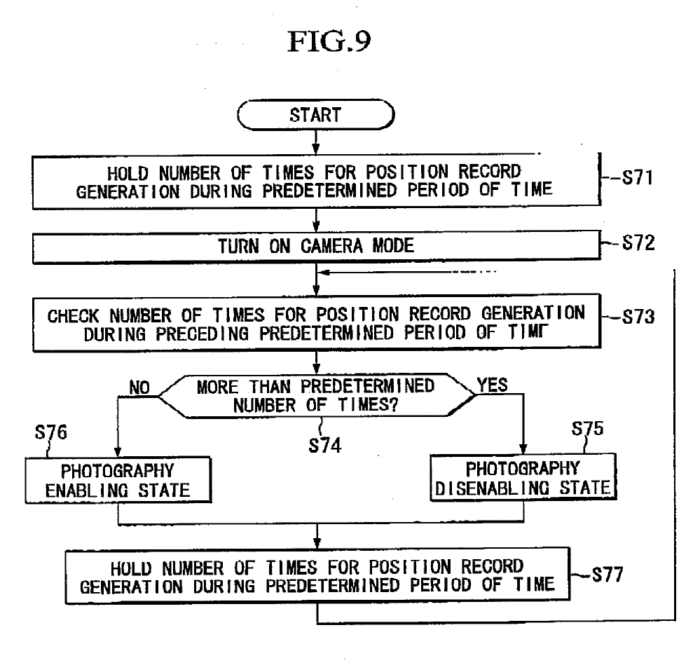

The sixth embodiment according to the invention will be described referring to the flowchart shown in FIG. 9.

The camera equipped portable terminal 100 always holds the number of times for position record generation of the camera equipped portable terminal 100 for a predetermined period of time (S71). When the camera equipped portable terminal 100 is set in a camera mode at this state (S72), the camera equipped portable terminal 100 checks the number of times for position record generation for a predetermined period of time (S73). If the number checked is greater than a predetermined number of times (S74, YES), the photograph disabling mode (S75) is selected. On the other hand, if the number checked is less than a predetermined number of times (S74, NO), the photograph enabling mode (S76) is selected. After holding the number of times for position record generation for a predetermined period of time (S77), the sequence of the flowchart proceeds to step S73.

A detection unit for detecting the number of times for position record generation is provided instead of the acceleration sensor 6 and the acceleration detector 7 in FIG. 1.

According to the fifth and sixth embodiments, since watching frequency of handoff or position record generation switches the camera over to the photograph disabling state of the photograph enabling state, photographic acts in a moving vehicle such as a train can be effectively prevented or deterred.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### INDUSTRIAL APPLICABILITY

The invention deters or prohibits pirating acts more effectively by a portable terminal such as a camera equipped portable terminal than in the prior art

1. A portable terminal comprising:
a photographic unit for photographing an object;
an acceleration sensor for measuring acceleration; and
a control unit for disenabling photographing by the photographic unit when the acceleration sensor produces a predetermined output after the photographic unit is set to a photographic mode.

2. The portable terminal according to claim 1, wherein, when, within a predetermined period of time after the photographic unit is put into a photograph disenabling state, the output of the acceleration sensor does not satisfy the predetermine output, the control unit cancels the photograph disenabling state after a predetermined period of time.

3. A portable terminal comprising:
a photographic unit for photographing an object;
an acceleration sensor for measuring acceleration; and
a control unit for prohibiting preservation of the data photographed by the photographic unit when the acceleration sensor produces a predetermined output after the photographic unit is set to a photographic mode.

4. A portable terminal comprising:
a photographic unit for photographing an object;
an acceleration sensor for measuring acceleration: and
a control unit for erasing the temporarily stored data photographed by the photographic unit and canceling a photographic mode when the acceleration sensor produces a predetermined output after the photographic unit is set to the photographic mode.

5. A portable terminal comprising:
a photographic unit for photographing an object;
an acceleration sensor for measuring acceleration; and
a control unit for prohibiting display of the data photographed by the photographic unit when the acceleration sensor produces a predetermined output after the photographic unit is set to the photographic mode.

6. A portable terminal comprising:
a photographic unit for photographing an object;
an acceleration sensor for measuring acceleration; and
a control unit for prohibiting preservation of the data photographed by the photographic unit and ending a photographic operation when the acceleration sensor produces a predetermined output during the time the photographic unit is photographing.

7. The portable terminal according to claim 1, further comprising a display unit for displaying acceleration measured by the acceleration sensor.

8. A portable terminal comprising:
a photographic unit for photographing an object;
a detector unit for detecting a number of times for handoff for a predetermined period of time;
a control unit for disenabling photographing by the photographic unit when the detector unit detects more than a predetermined number of times for handoff after the photographic unit is set to a photographic mode.

9. A portable terminal comprising:
a photographic unit for photographing an object;
a detector unit for detecting a number of times for position record for a predetermined period of time; and
a control unit for disenabling photographing by the photographic unit when the detector unit detects more position records than a predetermined number of times after the photographic unit is set to a photographic mode.

10. The portable terminal according to claim 3, further comprising a display unit for displaying acceleration measured by the acceleration sensor.

11. The portable terminal according to claim 4, further comprising a display unit for displaying acceleration measured by the acceleration sensor.

12. The portable terminal according to claim 5, further comprising a display unit for displaying acceleration measured by the acceleration sensor.

13. The portable terminal according to claim 6, further comprising a display unit for displaying acceleration measured by the acceleration sensor.
